(19) United States
(12) Patent Application Publication
(10) Pub. No.: US 2010/0210797 A1
(43) Pub. Date: Aug. 19, 2010

(54) Polyethylene Films having Improved Barrier Properties

(75) Inventors: Steven Gray, Florence, KY (US); David Knoeppel, League City, TX (US); Tim Coffy, Houston, TX (US); Kayo Vizzini, Pasadena, TX (US); Cyril Chevillard, Dickinson, TX (US); Shannon Hoesing, Louisville, CO (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/372,224

(22) Filed: Feb. 17, 2009

(51) Int. Cl. C08F 4/42; C08F 110/02

(52) U.S. Cl. 526/90; 526/352

(57) ABSTRACT

Blown films and processes of forming the same are described herein. The blown films generally include high density polyethylene exhibiting a molecular weight distribution of from about 1.5 to about 8.0 and a density of from 0.94 g/cc to less than 0.96 g/cc.

### FIELD

Embodiments of the present invention generally relate to polyethylene films. In particular, embodiments of the invention relate to high density polyethylene blown films having improved clarity and vapor barrier properties.

### BACKGROUND

Historically, polyethylene resins have found wide utility in producing blown films. The particular properties of the films, such as clarity and vapor barrier properties, depend upon both the type of polyethylene employed and the method of production, for example. However, achieving certain combinations of properties is difficult, as improving one property can adversely affect another. For example, medium density polyethylene (MDPE) and high density polyethylene (HDPE) can be employed to manufacture blown films. Generally, MDPE produces blown films having high clarity but low vapor barrier properties, while HDPE produces blown films having low clarity but high vapor barrier properties.

Therefore, a need exists to produce a polyethylene blown film having both high clarity and high vapor barrier properties.

### SUMMARY

Embodiments of the present invention include blown films. The blown films generally include high density polyethylene exhibiting a molecular weight distribution of from about 1.5 to about 8.0 and a density of from 0.94 g/cc to less than 0.96 g/cc.

Embodiments of the invention further include processes of forming blown films. In one or more embodiments, the processes generally include providing a high density polyethylene exhibiting a molecular weight distribution of from about 1.5 to about 8.0 and a density of from 0.94 g/cc to less than 0.97 g/cc and blowing the high density polyethylene into a film.

In another embodiment, the processes generally include contacting ethylene monomer into a continuous stirred tank reactor in the presence of a catalyst system under conditions sufficient to polymerize the ethylene monomer and form polyethylene, withdrawing the polyethylene, wherein the polyethylene includes high density polyethylene exhibiting a molecular weight distribution of from about 1.5 to about 8.0 and blowing the polyethylene into a film, wherein the film exhibits an oxygen vapor transmission rate of less than about 280 cc*mil/100 in²/day.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Embodiments of the invention generally provide unexpected polymers and processes for producing polyethylene films, and particularly polyethylene blown films, having both high clarity and high vapor barrier properties.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

In one or more embodiments, the Ziegler-Natta catalyst systems include magnesium-supported catalyst systems. For example, a magnesium-supported Ziegler-Natta catalyst can be prepared by a non-limiting, illustrative process having at least three sequential steps: (1) preparation of a metal dialkoxide as the reaction product of a metal dialkyl and an alcohol; (2) preparation of a soluble catalyst precursor as the reaction product of the metal dialkoxide and a halogenating/titanating agent; and (3) precipitation of a final solid catalyst component as the reaction product of the soluble catalyst precursor and a precipitating agent. The precipitating agent may in some embodiments also be a halogenating/titanating agent. The process may include further steps, such as additional halogenating/titanating steps, for example.

The metal dialkyls may include Group IIA metal dialkyls. In one or more embodiments, the metal dialkyl includes a magnesium dialkyl, for example. The magnesium dialkyl may include diethyl magnesium, dipropyl magnesium, dibutyl magnesium, butylethyl magnesium (BEM) and combinations thereof, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl, radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

In a specific embodiment, a slurry process may be carried out in a stirred reactor, such as a continuously stirred tank reactor (CSTR), for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polymers exhibit a uni-modal molecular weight distribution. As used herein, the term “uni-modal” refers to a polymer composition exhibiting a single peak on a molecular weight distribution plot. In contrast, multi-modal polymer compositions generally exhibit multiple peaks on a molecular weight distribution plot.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

The ethylene based polymers may have a narrow molecular weight distribution. As used herein, the term “narrow molecular weight distribution” refers to a polymer having a molecular weight distribution of from about 1.5 to about 8, or from about 2.0 to about 7.5, or from about 2.0 to about 7.0 or from about 4.5 to about 7.0, for example. Molecular weight distribution is represented herein by the “dispersion index” (D), which is the ratio of the average molecular weight by weight (Mₙ) to the average molecular weight by number (Mₙ); D=M_{w}/Mₙ. The dispersion index may also be referred to as “polydispersity” and is measured by gel permeation chromatograph (GPC).

The ethylene based polymers may have a density (as measured by ASTM D-792) of from about 0.86 g/cc to about 0.98 g/cc, or from about 0.88 g/cc to about 0.965 g/cc, or from about 0.90 g/cc to about 0.965 g/cc or from about 0.925 g/cc to about 0.97 g/cc, for example.

The ethylene based polymers may have a melt index (MI₂) (as measured by ASTM D-1238) of from about 0.01 dg/min to about 100 dg/min., or from about 0.01 dg/min. to about 25 dg/min., or from about 0.03 dg/min. to about 15 dg/min. or from about 0.05 dg/min. to about 10 dg/min, for example.

In one or more embodiments, the polymers include high density polyethylene. As used herein, the term “high density polyethylene” refers to ethylene based polymers having a density of from about 0.94 g/cc to about 0.97 g/cc, or from about 0.95 g/cc to about 0.97 g/cc or from about 0.95 to about 0.96, for example.

In one or more embodiments, the polymers include medium density polyethylene. As used herein, the term “medium density polyethylene” refers to ethylene based polymers having a density of from about 0.92 g/cc to about 0.94 g/cc, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one or more embodiments, the polymers and blends thereof are utilized to form blown films. Blown films may be formed by known processes such as processes wherein a molten polymer is pulled upwards from a die by nip rollers above the die, with the speed of the nip rollers determining the thickness of the film. An air-ring around the die may cool the film as it travels upwards. An air outlet then forces compressed air into the center of the extruded circular polymer, creating a “bubble” which expands the extruded circular cross section by a ratio, called the “blow-up ratio”, of up to 200 percent or more of the original diameter. The resulting film may be characterized by a variety of properties, both physical and functional, with the desired properties being determined by the intended use.

In one or more embodiments, the blown film exhibits a haze of about 20% or less, or about 15% or less or about 10% or less, for example. As used herein, the term “haze” refers to the percentage of transmitted light passing through a film and is measured with a haze meter according to the standard ASTM-D1003. Embodiments of the invention form blown films having improved clarity over blown films formed from high density polyethylene having a density of greater than 0.960 g/cc (e.g., “comparative polyethylene”) and in one or more embodiments have an unexpectedly similar clarity than films formed from medium density polyethylene.

In one or more embodiments, the blown films formed from the embodiments of the invention exhibit improved vapor barrier properties over blown films formed from medium density polyethylene, and, in one or more embodiments, exhibit greater vapor barrier properties than high density polyethylene having a density of greater than 0.960 g/cc. The vapor barrier properties are measured by determining of the transmission rate of a vapor per unit area of film per unit time. Typical vapors thus characterized include oxygen (O₂) and water (H₂O) vapor. In one or more embodiments, the blown films exhibit an oxygen transmission rate of about 300 cc*mil/100 in²/day or less or of about 280 cc/100 in²/day or less, for example. In one or more embodiments, the blown films exhibit a water vapor transmission rate of less than about 0.8 or less than about 0.6 g*mil/m²/day, for example.

### EXAMPLES

As used herein, Polymer “A” is a HDPE having a density of 0.9451 g/cc, an MI₂ of 1.23 dg/min., an average molecular weight of 122,495 and a polydispersity of 5.3.

As used herein, Polymer “B” is a HDPE having a density of 0.9622 g/cc, an MI₂ of 1.11 dg/min., an average molecular weight of 129,837 and a polydispersity of 6.8.

As used herein, Polymer “C” is a medium density polyethylene (MDPE) having a density of 0.9340 g/cc, an MI₂ of 0.88 dg/min., a molecular weight of 100,278 and a polydispersity of 3.6. As used herein, the term “medium density polyethylene” refers to ethylene based polymers having a density of from about 0.92 g/cc to about 0.94 g/cc or from about 0.926 g/cc to about 0.94 g/cc, for example.

### Example 1

The molecular weight distribution of the Polymers A and B were determined and the resulting GPC curve is shown in FIG. 1.

Blown films (1 mil thick) were prepared by from a variety of polymer samples. The resulting blown films were analyzed and the results are shown in Table 1 below.

TABLE 1

| Property | Polymer A | Polymer B | Polymer C |
|---|---|---|---|
| Haze (%) | 8.8 | 20.3 | 9.0 |
| O₂ Transmission | 275 | 304 | 280 |
| (cc/100 in²/day) | | | |
| H₂O Vapor Transmission | 8.98 | 10.69 | 0.65 |
| (cc/100 in² /day) | | | |

It was observed that the blown films formed from Polymer A exhibited better (i.e., lower) oxygen transmission rates than both Polymers B and C, while also unexpectedly exhibiting better (i.e., lower) haze than both Polymers B and C.

### Example 2

A variety of Polymers were formed from identical starting materials and catalyst systems. However, Polymer D was formed within a slurry loop reactor and Polymers E and F were formed within a CSTR.

Blown films were then prepared by from the resultant polymer samples. The resulting blown films were analyzed and the results and polymer properties are shown in Table 2 below.

TABLE 2

| Property | Polymer D | Polymer E | Polymer F |
|---|---|---|---|
| Density (g/cc) | 0.9578 | 0.9612 | 0.9607 |
| Haze (%) | 16 | 17 | 15.6 |
| 0₂ Transmission | 293 | 230 | 237 |
| (cc/100 in²/day) | | | |
| H₂O Vapor | 0.6 | 0.46 | 0.5 |
| Transmission | | | |
| (g/in² /day) | | | |
| MI₂ (dg/min) | 0.8 | 0.83 | 0.84 |
| HLMI | 24.1 | 28 | 28.2 |
| SR₂ | 30.1 | 33.7 | 34 |
| Mₙ | 22,973 | 19,654 | 20,909 |
| M_{w} | 127,422 | 134,764 | 136,756 |
| M_{z} | 540,796 | 691,530 | 681,719 |
| Polydispersity | 5.5 | 6.9 | 6.5 |
| (M_{w}/Mₙ) | | | |
| Gloss | 47 | 46 | 50 |

Unexpectedly, Polymers E and F formed in the CSTR exhibited significantly lower oxygen and water vapor transmission rates than the blown film formed from Polymer D.

While the foregoing is directed to embodiments of the present invention, other and further embodiments of the invention may be devised without departing from the basic scope thereof and the scope thereof is determined by the claims that follow.

What is claimed is:

1. A blown film comprising:
high density polyethylene exhibiting a molecular weight distribution of from about 1.5 to about 8.0 and a density of from 0.94 g/cc to less than 0.96 g/cc, wherein the film exhibits both a lower haze and a lower oxygen transmission rate than a blown film formed from a comparative high density polyethylene.

2. The blown film of claim 1, wherein the high density polyethylene exhibits a molecular weight distribution of from about 4.0 to about 7.0.

3. The blown film of claim 1, wherein a 1.0 mil thick film exhibits about 20% or less haze.

4. The blown film of claim 1, wherein a 1.0 mil thick film exhibits an O₂ transmission rate of about 300 cc/100 in²/day or less.

5. The blown film of claim 1, wherein a 1.0 mil thick film exhibits an O₂ transmission rate of about 280 cc/100 in²/day or less.

6. The blown film of claim 1, wherein a 1.0 mil thick film exhibits an water vapor transmission rate of about 0.8 cc/100 in²/day or less.

7. A process of forming blown film comprising:
providing a high density polyethylene exhibiting a molecular weight distribution of from about 1.5 to about 8.0 and a density of from 0.94 g/cc to less than 0.96 g/cc; and
blowing the high density polyethylene into a film.

8. A process of forming blown film comprising:
providing a high density polyethylene exhibiting a molecular weight distribution of from about 1.5 to about 8.0 and a density of from 0.94 g/cc to less than 0.96 g/cc; and
blowing the high density polyethylene into a film, wherein the film exhibits both a lower haze and a lower oxygen transmission rate than a blown film formed from a comparative high density polyethylene.

9. The process of claim 8, wherein the high density polyethylene exhibits a molecular weight distribution of from about 4.0 to about 7.0.

10. The process of claim 8, wherein a 1 mil thick film exhibits about 20% or less haze.

11. The process of claim 8, wherein a 1 mil thick film exhibits about 10% or less haze.

12. The process of claim 8, wherein a 1 mil thick film exhibits an O₂ transmission rate of about 300 cc/100 in²/day or less.

13. The process of claim 8, wherein a 1 mil thick film exhibits an O₂ transmission rate of about 280 cc/100 in²/day or less.

14. The process of claim 8, wherein a 1 mil thick film exhibits an O₂ transmission rate of about 0.8 cc/100 in²/day or less.

15. A process of forming a blown film comprising:
contacting ethylene monomer into a continuous stirred tank reactor in the presence of a catalyst system under conditions sufficient to polymerize the ethylene monomer and form polyethylene;
withdrawing the polyethylene, wherein the polyethylene comprises high density polyethylene exhibiting a molecular weight distribution of from about 1.5 to about 8.0; and
blowing the polyethylene into a film, wherein the film exhibits an oxygen vapor transmission rate of less than about 280 cc*mil/100 in²/day.

16. The process of claim 15, wherein a 1.0 mil thick film exhibits a haze of about 18% or less.

17. The process of claim 15, wherein the polyethylene exhibits a uni-modal molecular weight distribution.

18. The process of claim 15, wherein the catalyst system is formed by:
contacting a metal dialkoxide with a first halogenating/titanating agent to form reaction product “A”; and
contacting reaction product “A” with a second halogenating/titanating agent to form reaction product “B”, wherein the second halogenating/titanating agent is stronger than the first halogenating/titanating agent.

19. A blown film form by the process of claim 15.
